(19) United States
(12) Patent Application Publication
(10) Pub. No.: US 2011/0117296 A1
(43) Pub. Date: May 19, 2011

(54) ADHESIVE COMPOSITION, POLARIZING PLATE, AND LIQUID CRYSTAL DISPLAY

(75) Inventors: Ki Seok Jang, Daejeon (KR); In Cheon Han, Seoul (KR); Min Soo Park, Daejeon (KR)

(73) Assignee: LG CHEM, LTD., Seoul (KR)

(21) Appl. No.: 13/002,028

(22) PCT Filed: Jul. 1, 2009
(86) PCT No.: PCT/KR2009/003602

§ 371 Date: Dec. 29, 2010

(30) Foreign Application Priority Data
Jul. 1, 2008 (KR) 10-2008-0063381

(51) Int. Cl. C09J 7/02; C09J 133/08; C08K 5/053; C08K 5/17; C08F 2/46

(52) U.S. Cl. 428/1.33; 428/355 AC; 524/555; 524/386; 524/252; 522/174

(57) ABSTRACT

The present invention relates to a pressure-sensitive adhesive composition, including an interpenetrating polymer network structure in a cured state and comprising a pressure-sensitive adhesive strength stabilizer; a polarizer; and a liquid crystal display. In the present invention, by using the stabilizer having a functional group capable of rapidly reacting with a multifunctional crosslinking agent, the change of the pressure-sensitive adhesive strength over time is quickly terminated right after preparation, thereby the pressure-sensitive adhesive strength is rapidly stabilized. The pressure-sensitive adhesive of the present invention has an excellent removability in a room-temperature or warming condition. Also, the pressure-sensitive adhesive can efficiently suppress light leakage, and has an excellent workability and durability in a high-temperature and/or high-humidity condition.

### DETAILED DESCRIPTION OF THE INVENTION

1. Technical Field

The present invention relates to a pressure-sensitive adhesive composition, a polarizer and a liquid crystal display.

2. Background Art

A liquid crystal display (LCD) is a device displaying an image by injecting liquid crystal between two thin glass substrates. To manufacture the LCD, liquid crystal cells including liquid crystals interposed between substrates having transparent electrodes formed thereon, and polarizers are basically required, and suitable adhesives or pressure-sensitive adhesives have to be used for binding them.

The polarizer includes an iodine compound or a dichroic polarizing material aligned in a certain direction, and has a multi-layer structure in which triacetyl cellulose (TAC) protective films for protecting a polarizing film or element are formed on both sides. Various films constituting the multi-layer structure are made of materials having different molecular structures and compositions, and so have different physical properties. Therefore, in particular, under a high temperature and/or high humidity condition, the dimensional stability is insufficient according to variation in the shrinkage or expansion behavior of the materials having a unidirectional molecular alignment. As a result, if the polarizer is fixed by a pressure-sensitive adhesive, and stress is concentrated on a TAC layer under a high temperature or high humidity condition, leading to birefringence and thus light leakage.

As a method for solving the problem, a method of designing a pressure-sensitive adhesive to be very hard is known. If the pressure-sensitive adhesive has a high hardness, generated stress can be minimized by fully suppressing shrinkage and expansion of the polarizer in a high temperature and/or high humidity condition and can be concentrated on the outermost part of the polarizer, thereby achieving relatively excellent optical properties. However, in order to design a pressure-sensitive adhesive requires to be hard, a bulk modulus should be largely increased, and it leads to significant degradation in pressure-sensitive adhesive strength and thus degradation in endurance.

Since it is difficult to realize a bulk modulus to a level which can maintain excellent low light leakage and endurance at the same time merely with a typical single crosslinking structure, a method for improving the bulk modulus by mixing the conventional single crosslinking structure with a component such as a photo-initiator and multifunctional acrylate and using ultraviolet irradiation has been suggested (e.g., Japanese Patent Laid-Open Publication Nos. 2007-197659 and 2007-212995).

According to the techniques disclosed in the foregoing documents, due to the high crosslinking reaction speed of the multifunctional acrylate through the photo-initiator, the modulus of the pressure-sensitive adhesive, immediately after being cured by ultraviolet irradiation, sharply increases. As a result, a very long time should be taken to complete the time-dependent change of the pressure-sensitive adhesive strength, lowering productivity or workability.

That is, in a pressure-sensitive adhesive composition, curing reaction through a curing agent progresses slowly at room temperature and thus a long time from several days to several weeks is taken until the completion of the curing reaction. A process of keeping the pressure-sensitive adhesive composition at a particular temperature for a predetermined period of time to complete the curing reaction is called an aging process. In the aging process, the pressure-sensitive adhesive strength of the pressure-sensitive adhesive changes over time. In other words, the pressure-sensitive adhesive strength is highest immediately after coating, gradually decreases as the aging progresses, and finally has a specific value after completion of the curing reaction. The change of the pressure-sensitive adhesive strength during the aging process of the pressure-sensitive adhesive is called the time-dependent change of the pressure-sensitive adhesive strength.

A pressure-sensitive adhesive for a polarizer has to be shipped and then be applicable within 3 to 4 days from being prepared, in terms of productivity. Therefore, it is necessary to quickly complete the time-dependent change of the pressure-sensitive adhesive strength and guarantee the re-movability after attachment in a room temperature or warming condition, considering re-workability. Such requirements are increasing more and more as the size of LCDs increases.

However, according to the pressure-sensitive adhesive composition disclosed in the foregoing documents, the modulus of the pressure-sensitive adhesive sharply increases after UV irradiation for curing, delaying reaction between resin and a crosslinking agent and thus consuming a very long time until the completion of the time-dependent change of the pressure-sensitive adhesive strength. Moreover, if the pressure-sensitive adhesive composition disclosed in the foregoing documents is warmed after being attached before the completion of the curing reaction, large pressure-sensitive adhesive strength build-up occurs, significantly degrading the re-movability.

### Technical Problem

An object of the present invention is to provide a pressure-sensitive adhesive composition, a polarizer, and a liquid crystal display (LCD).

### Technical Solution

The present invention provides, as a means for achieving the foregoing object, a pressure-sensitive adhesive composition including interpenetrating polymer network in a cured state, wherein the composition comprises an acrylic resin, a multifunctional crosslinking agent, and a pressure-sensitive adhesive strength stabilizer.

The present invention provides, as another means for achieving the foregoing object, a polarizer including a polarizing film or polarizing element and a pressure-sensitive adhesive layer formed on a face or both faces of the polarizing film or polarizing element, the pressure-sensitive adhesive layer comprising a cured product of the pressure-sensitive adhesive composition according to the present invention.

The present invention provides, as another means for achieving the foregoing object, a liquid crystal display (LCD) comprising a liquid crystal panel in which the polarizer according to the present invention is attached on a face or both faces of a liquid crystal cell.

### Effects of the Invention

In the present invention, by using the stabilizer having a functional group capable of rapidly reacting with a multifunctional crosslinking agent, the change of the pressure-sensitive adhesive strength over time is quickly terminated right after preparation, thereby the pressure-sensitive adhesive strength is rapidly stabilized. The pressure-sensitive adhesive of the present invention has an excellent removability in a room-temperature or warming condition. Also, the pressure-sensitive adhesive can efficiently suppress light leakage, and has an excellent workability and durability in a high-temperature and/or high-humidity condition.

### MODE FOR CARRYING OUT THE INVENTION

The present invention relates to a pressure-sensitive adhesive composition including interpenetrating polymer network structure, which may be briefly referred to as an “IPN structure”, in a cured state, wherein the composition comprises acrylic resin, a multifunctional crosslinking agent, and a pressure-sensitive adhesive strength stabilizer.

Hereinafter, the pressure-sensitive adhesive composition according to the present invention will be described in detail.

The pressure-sensitive adhesive composition according to the present invention can include an IPN structure in a cured state. The term “cured state of pressure-sensitive adhesive composition” as used herein refers to a state in which the composition according to the present invention is prepared in the form of a pressure-sensitive adhesive through radial ray irradiation and/or heating. The term “radial ray” means an energy ray capable of causing curing reaction by affecting a polymerizable group or a polymerization initiator, and may be used as a concept including an electronic ray and an ultraviolet ray. The term “IPN structure” as used herein refers to a state where both a crosslinking structure formed by reaction between the acrylic resin and the multifunctional crosslinking agent (which may be referred to as a first crosslinking structure) and a separate crosslinking structure (which may be referred to as a second crosslinking structure) are realized at the same time in the pressure-sensitive adhesive.

The acrylic resin and the multifunctional crosslinking agent included in the pressure-sensitive adhesive composition according to the present invention may react with each other during curing and/or aging, thereby giving the first crosslinking structure to the pressure-sensitive adhesive.

In an embodiment of the present invention, the acrylic resin may have a weight average molecular weight of 1,000,000 or more. If the weight average molecular weight of the acrylic resin is less than 1,000,000 in the present invention, bubbles or peeling may occur in a high temperature and/or high humidity condition due to degradation in cohesive strength, thus deteriorating endurance reliability of the pressure-sensitive adhesive. In the present invention, the upper limit of the weight average molecular weight of the acrylic resin is not specifically limited, and for example, may be regulated within a range of 2,500,000 or less. If the weight average molecular weight of the acrylic resin exceeds 2,500,000, the endurance reliability of the pressure-sensitive adhesive may be degraded, or the coating property may be deteriorated due to viscosity increase.

In the present invention, a detailed composition of the acrylic resin is not specially limited. For example, according to an embodiment of the present invention, the acrylic resin may be a polymer of a monomer mixture including 80 to 99.9 parts by weight of a (meth) acrylic acid ester monomer and 0.1 to 20 parts by weight of a crosslinking monomer.

In the present invention, a detailed type of the (meth)acrylic acid ester monomer included in the monomer mixture is not specially limited, and for example, it may be alkyl (meth)acrylate. In this case, if an alkyl group included in the alkyl (meth)acrylate is excessively long, the cohesive strength of the pressure-sensitive adhesive is lowered and a glass transition temperature (T_{g}) or pressure-sensitive adhesive property may be difficult to regulate. For this reason, it is desirable to use alkyl (meth)acrylate having an alkyl group of 1 to 14 carbon atoms. Examples of such a monomer includes methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate, and tetradecyl (meth)acrylate, and in the present invention, a mixture of one kind or two or more kinds of the examples may be used. The monomer mixture according to the present invention may include the (meth)acrylic acid ester monomer in an amount of 80 to 99.9 parts by weight. If the content is less than 80 parts by weight, the initial adhesive strength of the pressure-sensitive adhesive may be lowered. If the content exceeds 99.9 parts by weight, a problem may occur in endurance due to degradation in cohesive strength.

The crosslinking monomer included in the monomer mixture according to the present invention is a monomer which can give a crosslinking functional group capable of reacting with the multifunctional crosslinking agent to be described later, to the acrylic resin, and can regulate the endurance reliability, the pressure-sensitive adhesive strength, and the cohesive strength of the pressure-sensitive adhesive.

Examples of the crosslinking monomer that can be used in the present invention may include, but not limited to, a hydroxy group-containing monomer, a carboxyl group-containing monomer, and a nitrogen-containing monomer. Examples of the hydroxy group-containing monomer may include, but not limited to, 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethyleneglycol (meth)acrylate, and 2-hydroxypropyleneglycol (meth)acrylate. Examples of the carboxyl group-containing monomer may include, but not limited to, (meth)acrylic acid, 2-(meth)acryloyloxy acetic acid, 3-(meth)acryloyloxy propyl acid, 4-(meth)acryloyloxy butyl acid, acrylic acid dimer, itaconic acid, maleic acid, and maleic acid anhydride. Examples of the nitrogen-containing monomer may include, but not limited to, (meth)acrylamide, N-vinyl pyrrolidone, and N-vinyl caprolactam. In the present invention, a mixture of one kind or two or more kinds of the examples may be used.

Preferably, in the monomer mixture according to the present invention, the crosslinking monomer is comprised in an amount of 0.1 to 20 parts by weight. If the content is less than 0.1 part by weight, the endurance reliability of the pressure-sensitive adhesive may be degraded. If the content exceeds 20 parts by weight, the crosslinking reaction may excessively progress, deteriorating pressure-sensitive adhesive property and/or peeling strength.

In the present invention, the monomer mixture may further include a compound expressed by Formula 1. The compound expressed by Formula 1 may be added for the purpose of regulating the glass transition temperature of the pressure-sensitive adhesive and adding other functions to the pressure-sensitive adhesive.

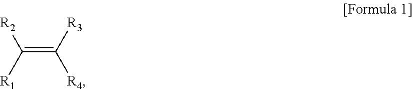

where R₁ to R₃ indicate, independently of one another, hydrogen or alkyl, and R₄ indicates cyano; phenyl substituted or unsubstituted with alkyl; acetyloxy; or COR₅, in which R₅ indicates glycidyloxy or amino substituted with alkyl or alkoxyalkyl.

In the definitions of R₁ to R₅, alkyl or alkoxy indicates alkyl or alkoxy of 1 to 8 carbon atoms, and preferably, methyl, ethyl, methoxy, ethoxy, propoxy, or butoxy.

Detailed examples of the monomer expressed by Formula 1 may include, but not limited to, one kind or two or more kinds of a nitrogen-containing monomer such as (meth)acrylonitrile, (meth)acrylamide, N-methyl (meth)acrylamide, or N-butoxy methyl (meth)acrylamide, a styrene monomer such as styrene or methyl styrene; an epoxy group-containing monomer such as glycidyl (meth)acrylate; and a carbonic acid vinyl ester such as vinyl acetate. If the monomer mixture according to the present invention includes the compound expressed by Formula 1, its content is preferably less than 20 parts by weight. If the content of the compound exceeds 20 parts by weight, the flexibility and/or peeling strength of the pressure-sensitive adhesive may be degraded. In the present invention, a method of preparing acrylic resin including the foregoing components is not specially limited, and for example, it may be prepared by using a general polymerization method such as solution polymerization, photo-polymerization, bulk polymerization, suspension polymerization, or emulsion polymerization. In the present invention, the acrylic resin may be prepared especially by using solution polymerization, and solution polymerization is preferably performed by mixing an initiator in a state where monomers are evenly mixed at a polymerization temperature of 50 to 140° C. Examples of the initiator that can be used in this course may include, but not limited to, mixtures of one kind or two or more kinds of an azo-based polymerization initiator such as azo-bisisobutyronitrile or azobiscyclohexane carbonitrile; and/or a common initiator like peroxide such as benzoyl peroxide or acetyl peroxide.

The pressure-sensitive adhesive composition according to the present invention includes a multifunctional crosslinking agent capable of giving a crosslinking structure by reacting with the acrylic resin.

A detailed type of the crosslinking agent that can be used in the present invention is not specially limited, and for example, a general crosslinking agent such as an isocyanate compound, an epoxy compound, an aziridine compound, or a metal chelate compound may be used. In the present invention, it is desirable to use, but not limited to, the isocyanate compound among the foregoing examples. A detailed example of the isocyanate compound may be, but not limited to, one or more selected from a group consisting of toluene diisocyanate, xylene diisocyanate, diphenylmethane diisocyanate, hexamethylene diisocyanate, isophorone diisocyanate, tetramethylxylene diisocyanate, naphthalene diisocyanate, and a reaction product between at least one of the foregoing isocyanates and polyol such as trimethylolpropane. A detailed example of the epoxy compound may, but not limited to, be one or more selected from a group consisting of ethyleneglycol diglycidylether, triglycidylether, trimethylolpropane triglycidylether, N,N,N′,N′-tetraglycidyl ethylenediamine, and glycerine diglycidylether. A detailed example of the aziridine compound may be one or more selected from a group consisting of N,N′-toluene-2,4-bis(1-aziridinecarboxamide), N,N-diphenylmethane-4,4′-bis(1-aziridinecarboxamide), triethylene melamine, bisisoprothaloyl-1-(2-methylaziridine), and tri-1-aziridinylphosphineoxide. A detailed example of the metal chelate compound may be, but not limited to, one or more selected from a group consisting of compounds prepared by coordinating multivalent metal such as Al, Fe, Zn, Sn, Ti, Sb, Mg, or V with acethylacetone or ethyl acetoacetate.

In the pressure-sensitive adhesive composition according to the present invention, the crosslinking agent may be comprised in an amount of 0.01 to 10 parts by weight, and more preferably 0.01 to 5 parts by weight relative to 100 parts by weight of the acrylic resin. If the content of the crosslinking agent is less than 0.01 parts by weight, the cohesive strength of the pressure-sensitive adhesive may be degraded. If the content exceeds 10 parts by weight, interlayer peeling or lifting may occur, deteriorating endurance reliability.

The pressure-sensitive adhesive composition according to the present invention includes, together with the foregoing components, a pressure-sensitive adhesive strength stabilizer. The term “pressure-sensitive adhesive strength stabilizer” as used herein refers to a compound which includes a functional group capable of reacting with the multifunctional crosslinking agent so that it can accelerate the reaction between the acrylic resin and the multifunctional crosslinking agent and reduce the time required for the stabilization of the pressure-sensitive adhesive strength, for example, even when the modulus of the pressure-sensitive adhesive largely increases due to UV irradiation, and the like. An example of the functional group that can be included in the pressure-sensitive adhesive stabilizer may be, but not limited to, a hydroxy group, an amine group, a carboxyl group, or an epoxy group, and preferably the hydroxy group or the amine group.

In the present invention, for example, as the pressure-sensitive adhesive strength stabilizer, polyol (polyhydric alcohol) or polyamine (polyhydric amine) may be used.

In the present invention, for example, it is desirable to use, but not limited to, dihydric to hexavalent, preferably dihydric to tetravalent, more preferably dihydric to trivalent polyol or polyamine having a molecular weight of about 50 to 3,000.

A detailed example of polyol that can be used in the present invention may be, but not limited to, alkyleneglycol, dialkyleneglycol, benzenediol (e.g., catechol, resorcinol, or hydroquinone), benzenetriol (e.g., 1,2,3-benzenetriol), dialcoholamine, trialcoholamine, arabitol, mannitol, isomalt, glycerol, xylitol, sorbitol, maltitol, erythritol, ribitol, dulcitol, lactitol, threitol, iditol, or polyglycitol, and an example of polyamine may be, but not limited to, alkylenediamine, alkenylenediamine, phenylenediamine (e.g., m-phenylenediamine), or n-aminoalkyl alkanediamine.

The alkyleneglycol or dialkyleneglycol may be alkyleneglycol or dialkyleneglycol having 1 to 12 carbon atoms, preferably 1 to 8 carbon atoms, more preferably 1 to 4 carbon atoms, and more specifically, may be ethyleneglycol, propyleneglycol, 1,3-butane diol, 1,4-butane diol, diethyleneglycol, or dipropyleneglycol.

The dialcoholamine or trialcoholamine may be dialcoholamine or trialcoholamine having 1 to 12 carbon atoms, preferably 1 to 8 carbon atoms, more preferably 1 to 4 carbon atoms, and more specifically, may be diethanolamine, dipropanolamine, triethanolamine, or tripropanolamine.

The alkylenediamine may be alkylenediamine having 1 to 12 carbon atoms, preferably 1 to 8 carbon atoms, more preferably 1 to 4 carbon toms, and more specifically, may be ethylendiamine, 1,2-diaminopropane, or diaminobutane.

The alkenylenediamine may be alkenylenediamine having 2 to 12 carbon atoms, preferably 2 to 8 carbon atoms, more preferably 2 to 4 carbon atoms, and more specifically, may be propendiamine or butendiamine.

The n-aminoalkyl alkanediamine may include alkyl having 1 to 12 carbon atoms, preferably 1 to 8 carbon atoms, more preferably 1 to 4 carbon atoms, and more specifically, may be spermidine.

In the present invention, the pressure-sensitive adhesive strength stabilizer may be comprised in an amount of 0.1 to 10 equivalents, preferably 0.1 to 5 equivalent, more preferably 0.5 to 2 equivalent relative to 1 equivalent of the multifunctional crosslinking agent. If the content of the pressure-sensitive adhesive strength stabilizer is less than 0.1 equivalents, the effect of reducing the time required for the time-dependent change of the pressure-sensitive adhesive strength may be insufficient. If the content exceeds 10 equivalents, other physical properties of the pressure-sensitive adhesive such as peeling strength may be degraded.

In the pressure-sensitive adhesive composition according to the present invention, components, which are included together with the acrylic resin and the multifunctional crosslinking agent torealize the second crosslinking structure, is not specifically limited. That is, in the present invention, any components can be used if they can realize the second crosslinking structure in the pressure-sensitive adhesive by reaction with each other while having low reactivity with the acrylic resin and the multifunctional crosslinking agent. For example, as a component for implementing the second crosslinking structure in the present invention, multifunctional acrylate and a polymerization initiator may be included.

In this case, a type of the multifunctional acrylate that can be used is not specifically limited. In the present invention, for example, bifunctional acrylate such as 1,4-butane diol di(meth)acrylate, 1,6-hexanediol di(meth)acrylate, neopentylglycol di(meth)acrylate, polyethyleneglycol di(meth)acrylate, neopentylglycol adipate di(meth)acrylate, hydroxy puivalic acid neopentylglycol di(meth)acrylate, dicyclopentanyl di(meth)acrylate, caprolactone modified dicyclopentenyl di(meth)acrylate, ethyleneoxide modified di(meth)acrylate, di(meth)acryloxy ethyl isocyanurate, allyl cyclohexyl di(meth)acrylate, tricyclodecane dim ethanol(meth)acrylate, dimethylol dicyclopentane di(meth)acrylate, ethyleneoxide modified hexahydrophtalic acid di(meth)acrylate, tricyclodecane dimethanol(meth)acrylate, neopentylglycol modified trimethylpropane di(meth)acrylate, adamantane di(meth)acrylate, or 9,9-bis[4-(2-acryloyloxyethoxy)penyl]fluorine; trifunctional acrylate such as trimethylolpropane tri(meth)acrylate, dipentaerythritol tri(meth)acrylate, propionic acid modified dipentaerythritol tri(meth)acrylate, pentaerythritol tri(meth)acrylate, propyleneoxide modified trimethylolpropane tri(meth)acrylate, 3 functional urethane (meth)acrylate, or tris(meth)acryloxyethylisocyanurate; tetrafunctional acrylate such as diglycerine tetra(meth)acrylate or pentaerythritol tetra(meth)acrylate; octafunctional acrylate such as propionic acid modified dipentaerythritol penta(meth)acrylate; and hexafunctional acrylate such as dipentaerythritol hexa(meth)acrylate, caprolactone modified dipenta erythritol hexa(meth)acrylate, or urethane (meth)acrylate (e.g., isocyanate monomer and reactants with trimethylolpropane tri(meth)acrylate may be used, without being limited thereto.

In the present invention, mixtures of one kind or two or more kinds of the foregoing examples of the multifunctional acrylate may be used, without being limited thereto. In particular, it is desirable to use, but not limited to, trifunctional or higher functional acrylate having a molecular weight of less than 1,000 to achieve excellent endurance.

In an embodiment of the present invention, it is desirable to use the multifunctional acrylate which includes a ring structure in its molecular structure. By using such acrylate, the pressure-sensitive adhesive can be formed harder, thus additionally enhancing the light leakage suppression effect. In this case, the ring structure included in acrylate may be any one of a carbocyclic structure or a heterocyclic structure; and a monocyclic or polycyclic structure. A detailed example of the multifunctional acrylate including the ring structure may be, but not limited to, a monomer having an isocyanurate structure such as tris(meth)acryloxy ethyl isocyanurate or a hexafunctional acrylate such as isocyanate modified urethane (meth)acrylate (e.g., isocyanate monomer and reactants with trimethylolpropane tri(meth)acrylate).

In the pressure-sensitive adhesive composition according to the present invention, the multifunctional acrylate may be comprised in an amount of 5 to 40 parts by weight relative to 100 parts by weight of the acrylic resin. If the content of the multifunctional acrylate is less than 5 parts by weight, endurance may be degraded in a high temperature condition or light leakage suppression effect may be degraded. If the content exceeds 40 parts by weight, high-temperature endurance may be deteriorated.

A type of the polymerization initiator which can realize the second crosslinking structure together with the multifunctional acrylate in the pressure-sensitive adhesive composition according to the present invention is not specially limited. For example, one or more selected from a group consisting of a photo-initiator and a thermal initiator may be used as the polymerization initiator, and in particular, it is desirable to use both the photo-initiator and the thermal initiator at the same time. As such, by including the photo-initiator and the thermal initiator at the same time in the pressure-sensitive adhesive composition, various physical properties, including low light leakage property of the pressure-sensitive adhesive, may be further improved. The polymerization initiator may be comprised in an amount of 0.2 to 20 parts by weight relative to 100 parts by weight of the acrylic resin.

In the present invention, as the photo-initiator, any component can be used if it can implement the second crosslinking structure by reacting with the aforementioned multifunctional acrylate during the curing process of the pressure-sensitive adhesive through UV irradiation. A type of the photo-initiator that can be used in the present invention is not particularly limited, and for example, may be benzoin, benzoin methylether, benzoin ethylether, benzoin isopropylether, benzoin n-butylether, benzoin isobutylether, acetophenone, dimethylamino acetophenone, 2,2-dimethoxy-2-penylacetophenone, 2,2-diethoxy-2-penylacetophenone, 2-hydroxy-2-methyl-1-penylpropane-1-on, 1-hydroxycyclohexylphenylketone, 2-methyl-1-[4-(methyltio)penyl]-2-morpholino-propane-1-on, 4-(2-hydroxyethoxy)penyl-2-(hydroxy-2-propyl)ketone, benzophenone, p-penylbenzophenone, 4,4′-diethylaminobenzophenone, dichlorobenzophenone, 2-methylanthraquinon, 2-ethylanthraquinon, 2-t-butylanthraquinon, 2-aminoanthraquinon, 2-methyl thioxanthone, 2-ethylthioxanthone, 2-chlorothioxanthone, 2,4-dimethylthioxanthone, 2,4-diethylthioxanthone, benzyldimethylketal, acetophenone dimethylketal, p-dimethylamino benzoic acid ester, oligo[2-hydroxy-2-methyl-1-[4-(1-methylvinyl)penyl]propanone], or 2,4,6-trimethylbenzoyl-diphenyl-phosphine oxide. In the present invention, one kind or two or more kinds of the foregoing examples may be used, without being limited thereto.

In the pressure-sensitive adhesive composition according to the present invention, the photo-initiator may be comprised in an amount of 0.2 to 20 parts by weight, preferably 0.2 to 10 parts by weight, more preferably 0.2 to 5 parts by weight relative to 100 parts by weight of the acrylic resin. More specifically, in the composition according to the present invention, the photo-initiator is included preferably in an amount of 0.2 to 20 parts by weight relative to 100 parts by weight of the multifunctional acrylate. If the content of the photo-initiator is out of that range, the reaction with the multifunctional acrylate may not progress smoothly or the physical properties of the pressure-sensitive adhesive may be deteriorated due to residues after the reaction.

A type of the thermal initiator that can be used in the present invention is not particularly limited, and can be properly selected considering desired physical properties. For example, in the present invention, a thermal initiator having a 10-hours half-life temperature of not less than 40° C. and less than 100° C. may be used. By setting the half-life temperature of the thermal initiator in that way, the pot-life can be sufficiently secured and the dry temperature for decomposing the thermal initiator can be properly maintained.

A type of the thermal initiator that can be used in the present invention is not particularly limited if it has the foregoing physical properties, and for example, a general initiator such as an azo-based compound, a peroxide compound, or a redox compound may be used. Examples of the azo-based compound may include, but not limited to, 2,2′-azobis(2-methylbutyronitrile), 2,2′-azobis(isobutyronitrile), 2,2′-azobis(2,4-dimethylvaleronitrile), 2,2′-azobis-2-hydroxymethylpropionitrile, dimethyl-2,2′-azobis(2-methylpropionate), and 2,2′-azobis(4-methoxy-2,4-dimethylvaleronitrile). Examples of the peroxide compound may include, but not limited to, inorganic peroxides such as potassium persulfate, ammonium persulfate, or hydrogen peroxide; and organic peroxides such as diacyl peroxide, peroxy dicarbonate, peroxy ester, tetramethylbutylperoxy neodecanoate (e.g., Perocta ND, NOF (manufacturer)), bis(4-butylcyclohexyl)peroxydicarbonate (e.g., Peroyl TCP, NOF (manufacturer)), di(2-ethylhexyl)peroxy carbonate, butylperoxy neodecanoate (e.g., Perbutyl ND, NOF (manufacturer)), dipropyl peroxy dicarbonate (e.g., Peroyl NPP, NOF (manufacturer)), diisopropyl peroxy dicarbonate (e.g., Peroyl IPP, NOF (manufacturer)), diethoxyethyl peroxy dicarbonate (e.g., Peroyl EEP, NOF (manufacturer)), diethoxyhexyl peroxy dicarbonate (e.g., Peroyl OEP, NOF (manufacturer)), hexyl peroxy dicarbonate (e.g., Perhexyl ND, NOF (manufacturer)), dimethoxybutyl peroxy dicarbonate (e.g., Peroyl MBP, NOF (manufacturer)), bis(3-methoxy-3-methoxybutyl) peroxy dicarbonate (e.g., Peroyl SOP, NOF (manufacturer)), dibutyl peroxy dicarbonate, dicetylperoxy dicarbonate, dimyristylperoxy dicarbonate, 1,1,3,3-tetramethylbutyl peroxypivalate, hexyl peroxypivalate (e.g., Perhexyl PV, NOF (manufacturer)), butyl peroxypivalate (e.g., Perbutyl, NOF (manufacturer)), trimethyl hexanoyl peroxide (e.g., Peroyl 355, NOF (manufacturer)), dimethyl hydroxybutyl peroxyneodecanoate (e.g., Luperox 610M75, Atofina (manufacturer)), amyl peroxyneodecanoate (e.g., Luperox 546M75, Atofina (manufacturer)), butyl peroxyneodecanoate (e.g., Luperox 10M75, Atofina (manufacturer)), t-butylperoxy neoheptanoate, amylperoxy pivalate (e.g., Luperox 546M75, Alofina (manufacturer)), t-butylperoxy pivalate, t-amyl peroxy-2-ethylhexanoate, lauryl peroxide, dilauroyl peroxide, didecanoyl peroxide, benzoyl peroxide, or dibenzoyl peroxide. Examples of the redox compound may include, but not limited to, a mixture using a peroxide compound and a reducing agent. In the present invention, a mixture of one kind or two or more kinds of the azo-based compound, the peroxide compound, and the redox compound may be used.

In the composition according to the present invention, the thermal initiator may be comprised in an amount of 0.2 to 20 parts by weight, preferably 0.2 to 5 parts by weight, relative to 100 parts by weight of the acrylic resin. If the content of the thermal initiator is less than 0.2 part by weight, the low light leakage property of the pressure-sensitive adhesive may be degraded. If the content is in excess of 20 parts by weight, the endurance reliability of the pressure-sensitive adhesive may be deteriorated.

The pressure-sensitive adhesive composition according to the present invention may include, in addition to the above-described components, a silane coupling agent. The coupling agent functions to improve heat resistance and moisture resistance by enhancing adhesion and adhesion stability between the pressure-sensitive adhesive and the glass substrates, and to improve adhesion reliability when the pressure-sensitive adhesive is left for a long time in a high temperature and/or high humidity condition. Examples of the coupling agent that can be used in the present invention may include mixtures of one kind or two or more kinds of γ-glycidoxypropyl triethoxy silane, γ-glycidoxypropyl trimethoxy silane, γ-glycidoxypropyl methyldiethoxy silane, γ-glycidoxypropyl triethoxy silane, 3-mercaptopropyl trimethoxy silane, vinyltrimethoxysilane, vinyltriethoxy silane, γ-methacryloxypropyl trimethoxy silane, γ-methacryloxy propyl triethoxy silane, γ-aminopropyl trimethoxy silane, γ-aminopropyl triethoxy silane, 3-isocyanato propyl triethoxy silane, γ-acetoacetatepropyl trimethoxysilane, γ-acetoacetatepropyl triethoxy silane, β-cyanoacetyl trimethoxy silane, β-cyanoacetyl triethoxy silane, and acetoxyaceto trimethoxy silane. In the present invention, it is desirable to use, but not limited to, a silane coupling agent having acetoacetate group or a β-cyanoacetyl group. In the present invention, the silane coupling agent may be comprised in an amount of 0.01 to 5 parts by weight, preferably 0.01 to 1 part by weight, relative to 100 parts by weight of the acrylic resin. If the content is less than 0.01 part by weight, the pressure-sensitive adhesive strength increase may be insufficient. If the content exceeds 5 parts by weight, the endurance reliability may be degraded.

The pressure-sensitive adhesive composition according to the present invention may further include 1 to 100 parts by weight of tackifier relative to 100 parts by weight of the acrylic resin in order to regulate pressure-sensitive adhesive performance. A type of the tackifier resin is not specifically limited, and for example, a mixture of one kind or two or more kinds of (hydrogenated) hydrocarbon resin, (hydrogenated) rosin resin, (hydrogenated) rosin ester resin, (hydrogenated) terpene resin, (hydrogenated) terpene phenol resin, polymerized rosin resin, or polymerized rosin ester resin. If the content of the tackifier resin is less than 1 part by weight, the addition effect may be insufficient. If the content exceeds 100 parts by weight, the compatibility and/or cohesive strength improving effect may be degraded.

In a range that cannot affect the effect of the present invention, the pressure-sensitive adhesive composition according to the present invention may further include one or more additives selected from a group consisting of epoxy resin, a curing agent, an UV stabilizer, an antioxidant, a coloring agent, a reinforcing agent, a filler, an anti-foamer, a surfactant, and a plasticizer.

The present invention relates to a polarizer including a polarizing film or polarizing element and a pressure-sensitive adhesive layer formed on a face or both faces of the polarizing film or polarizing element, the pressure-sensitive adhesive layer comprising a cured product of the pressure-sensitive adhesive composition according to the present invention.

A type of the polarizing film or polarizing element forming the polarizer is not specifically limited. For example, in the present invention, as the polarizing film or polarizing element, a film prepared by adding a polarization component such as iodine or dichroic dyes onto a polyvinyl alcohol resin film and elongating it may be used. Said polyvinyl alcohol resin may comprise polyvinyl alcohol, polyvinyl formal, polyvinyl acetal and hydrolysate of ethylene-vinyl acetate copolymer, and the like. Also, there is no limitation in the thickness of the polarization film and so the polarization film may be made in conventional thickness.

The polarizer may be formed as a multilayer film, wherein protective films, such as a cellulose film, for example, triacetyl cellulose; a polyester film, for example a polycarbonate film or a polyethylene terephthalate; a polyether sulphone film; and/or a polyolefin film, for example, polyethylene film, polypropylene film, polyolefin film having cyclo or norbornene structure, or ethylene-propylene copolymer, are laminated on one or both sides of the polarizing film. At this time, the thickness of these protective films is also not particularly restricted. It may be formed in a usual thickness.

In the present invention, a method of forming the pressure-sensitive adhesive layer on the polarizing film or polarizing element is not specifically limited. For example, the method may include coating the pressure-sensitive adhesive composition (coating liquid) on the film or element with a general means such as a bar coater and then curing it, or coating the pressure-sensitive adhesive composition on the surface of the releasable substrate followed by curing and transferring the pressure-sensitive adhesive layer onto the surface of the polarizing film or polarizing element. In this process, it is preferable that the multifunctional crosslinking agent included in the pressure-sensitive adhesive composition (coating liquid) is regulated such that the crosslinking reaction of the functional group does not progress for uniform coating. Thus, the crosslinking agent forms a crosslinking structure during curing and aging processes after coating, thereby improving the cohesive strength of the pressure-sensitive adhesive and the pressure-sensitive adhesive physical property and cuttability.

It is desirable to perform the process of forming the pressure-sensitive adhesive layer after a volatile component or a bubble inducing component such as a reaction residue in the pressure-sensitive adhesive composition or coating liquid is sufficiently removed. If the modulus of elasticity decreases due to excessively low crosslinking density or molecular weight, small bubbles existing between the glass plate and the pressure-sensitive adhesive layer grow big, forming scatters in the pressure-sensitive adhesive composition or coating liquid, but such problems can be prevented by sufficiently removing the volatile component or the bubble inducing component.

In the preparation of the polarizer, a method of curing the pressure-sensitive adhesive composition according to the present invention is not particularly limited, and for example, the curing may be performed by applying proper heat sufficient for activating the heat initiator included in the composition or irradiating radial rays such as UV rays or electronic rays capable of causing activation of the photo-initiator. In the present invention, the pressure-sensitive adhesive layer may be formed by using both thermal curing and radiation curing at the same time.

In the present invention, if irradiation of radial rays, e.g., UVs, is applied, the UV irradiation may performed by using, for example, high-pressure mercury lamp, an induction lamp, or a xenon lamp. The amount of irradiation in UV curing is not specifically limited if it does not damage overall physical properties and provides sufficient curing, and for example, it is preferable that the intensity of illumination is 50 to 1,000 mW/cm² and the intensity of radiation is 50 to 1,000 mJ/cm².

In the present invention, the pressure-sensitive adhesive layer prepared through the foregoing process has gel in a content of 80 to 99%, preferably 90 to 99%, the gel expressed by:

Gel Content (%)=B/A×100, [General Formula 1]

where A represents a weight of the pressure-sensitive adhesive, and B represents a dry weight of an undissolved part of the pressure-sensitive adhesive after soaking the pressure-sensitive adhesive in ethyl acetate at room temperature for 48 hours

If the gel content is less than 80%, the endurance reliability of the pressure-sensitive adhesive in a high temperature and/or high humidity condition may be degraded. If the gel content exceeds 99%, the stress relaxing feature of the pressure-sensitive adhesive may be deteriorated.

The polarizer according to the present invention may further include one or more functional layers selected from a group consisting of a protective layer, a reflective layer, an anti-glare layer, a phase retardation plate, a compensation film for wide view angle, and a brightness enhancing film.

The present invention also relates to a liquid crystal display (LCD) including a liquid crystal panel in which the polarizer according to the present invention is attached on a face or both faces of a liquid crystal cell.

A type of a liquid crystal cell forming the LCD according to the present invention is not specifically limited, and includes a general liquid crystal cell such as of a twisted neumatic (TN) type, a super twisted neumatic (STN) type, or a vertical alignment (VA) type. A type of and a manufacturing method for other structures included in the LCD according to the present invention are not specially limited, either, and a general structure in this field can be adopted without limit.

### EMBODIMENTS

Hereinafter, the present invention will be described in more detail with reference to examples according to the present invention and comparative examples which do not accord to the present invention, but the scope of the present invention is not limited by the examples to be described below.

### Example 1

### Preparation of Acrylic Copolymer

To a 1 L reactor refluxed with nitrogen gas and equipped with a cooling system for easy regulation of temperature, 99 parts by weight of n-butyl acrylate(n-BA) and 1.0 part by weight of hydroxybutyl acrylate(HBA) were added. Next, 120 parts by eight of ethyl acetate(EAc) was added as a solvent, and nitrogen gas was purged for 60 minutes to remove oxygen. Thereafter, the reactor was kept at 60° C., and 0.03 part by weight of azobisisobutyronitrile(AIBN) was put as a reaction initiator, followed by 8-hr reaction, thereby preparing acrylic resin having a weight average molecular weight of 1,700,000 and a molecular weight distribution M_{w}/Mₙ of 3.4.

### Preparation of Pressure-Sensitive Adhesive Composition

By mixing 15 parts by weight of tris(acryloxyethyl)isocyanurate (molecular weight:423, trifunctional, aronix M-315), 1.5 parts by weight of 1-hydroxycyclohexyl phenyl ketone as a photo-polymerization-initiator, 1.5 parts by weight of trimethylol-modified tolylene diisocyanate (coronate-L) as a crosslinking agent, 0.12 part by weight of a silane coupling agent, and 1.5 part by weight of 1,4-butane diol as a pressure-sensitive adhesive strength stabilizer relative to 100 parts by weight of the prepared acrylic resin, a pressure-sensitive adhesive composition was prepared.

### Preparation of Pressure-Sensitive Adhesive Polarizer

The prepared pressure-sensitive adhesive composition was dried on a PET film (Mitsubishi, MRF-38), which is a releasing-treated peeling sheet and has a thickness of 38 μm, and then was coated to a thickness of 25 μm, followed by 3-min drying in an oven of 110° C. Thereafter, the dried coating layer was kept at a constant temperature/humidity room (23° C., 55% RH) for about 24 hours and then the pressure-sensitive adhesive layer was lamination-treated on a wide view (WV) coating layer of the polarizer, on a single side of which a WV liquid crystal layer was coated. Next, UV irradiation was performed on the following conditions, thereby preparing a pressure-sensitive adhesive polarizer.

UV Exposurer: High-pressure mercury lamp

Irradiation Conditions: Illumination Intensity=600 mW/cm², Radiation Intensity=150 mJ/cm²

### Example 2

Except that 1.5 part by weight of 1,6-hexane diol was added as a pressure-sensitive adhesive strength stabilizer in place of 1,4-butane diol, a pressure-sensitive adhesive polarizer was prepared in the same manner as Example 1.

### Example 3

Except that 1.5 part by weight of hexamethylenediamine was added as a pressure-sensitive adhesive strength stabilizer in place of 1,4-butane diol, a pressure-sensitive adhesive polarizer was prepared in the same manner as Example 1.

### Comparative Example 1

Except that 1,4-butane diol as a pressure-sensitive adhesive strength stabilizer was not mixed, a pressure-sensitive adhesive polarizer was prepared in the same manner as Example 1.

For the pressure-sensitive adhesives prepared in Examples and Comparative Example, performance was measured in manners described below.

### 1. Peeling Strength Evaluation

The pressure-sensitive adhesive polarizers prepared in Examples and Comparative Example were cut into a size of 25 mm×100 mm to prepare samples, and peeling sheets were removed, after which they were attached to alkali-free glass by using a laminator. Next, compression was performed for about 20 minutes in an autoclave (50° C., 5 atm), and then it was kept for 4 hours in a constant temperature/humidity condition (23° C., 50% RH). The pressure-sensitive adhesive strength was measured by using a texture analyzer (England Stable Micro System) at a peeling speed of 300 mm/min and at a peeling angle of 180°. The measurement of the pressure-sensitive adhesive strength was measured after 2, 4, and 9 days from attachment at 23° C., and was measured after 2, 4, and 9 days from 4-hr aging at 50° C.

### 2. Endurance Reliability Evaluation

The pressure-sensitive adhesive polarizers prepared in Examples and Comparative Example were cut into a size of 90 mm×170 mm to prepare specimens, and were attached to both sides of a glass substrate (110 mm×190 mm×0.7 mm), with each optical absorbing axis crossed, thereby preparing samples. The above process was carried out in a clean room in order to prevent bubbles or impurities generation, and the applied pressure for attachment was about 5 kg/cm². In order to evaluate moisture-heat resistance of the specimens, they were left at a temperature of 60° C. and a relative humidity of 90% for 1,000 hours and then observed about formation of bubbles or releases. For heat resistance of the specimens, they were left at a temperature of 80° C. for 1,000 hours and then observed about formation of bubbles or releases. The specimens were left at room temperature for 24 hours immediately before evaluation of their states. The evaluation criteria for endurance reliability were as follows:

◯: No bubble or release phenomenon was observed.

Δ: A few bubbles or release phenomenon occurred.

X: A large quantity of bubbles or release phenomenon occurred.

### 3. Light Transmission Uniformity (Light Leakage) Evaluation

By using the same specimens as endurance reliability evaluation, the uniformity of light transmission was measured. It was observed about whether light was leaked in a dark room by irradiating back light to the specimens. More specifically, the pressure-sensitive adhesive polarizer (200 mm×200 mm) was attached to both sides of the glass substrate (210 mm×210 mm×0.7 mm) crossed at 90°, and then observed. The uniformity of light transmission was evaluated with the following criteria:

⊙: Non-uniformity phenomenon of light transmission was difficult to determine by the naked eye.

◯: Some few non-uniformity phenomenon of light transmission was present.

Δ: More or less non-uniformity phenomenon of light transmission was present.

X: A large quantity of non-uniformity phenomenon of light transmission was present.

Such physical property measurement results were arranged in Tables 7 to 11.

TABLE 1

| | | | | | | Comparative |
|---|---|---|---|---|---|---|
| | | | Example 1 | Example 2 | Example 3 | Example 1 |
| Peeling | 23° C. | 2 days | 2,270 | 2,304 | 2,620 | 2,160 |
| Strength | | 4 days | 361 | 570 | 461 | 1,378 |
| (N/25 mm) | | 9 days | 283 | 346 | 311 | 231 |
| | 50° C., | 2 days | 4,460 | 4,340 | 4,160 | 4,500 |
| | 4 hrs, | 4 days | 1,161 | 1,211 | 1,423 | 2,812 |
| | aging | 9 days | 564 | 490 | 343 | 312 |

| | | | | | |
|---|---|---|---|---|---|
| Endurance | Moisture Resistance | ◯ | ◯ | ◯ | ◯ |
| Reliability | Condition | | | | |
| | (60° C., 90% R.H., | | | | |
| | 1,000 hrs) | | | | |
| | Heat Resistance | ◯ | ◯ | ◯ | ◯ |
| | Condition | | | | |
| | (80° C., 1,000 hrs) | | | | |

| | | | | |
|---|---|---|---|---|
| Uniformity of Light Transmission | ⊚ | ⊚ | ◯ | ◯ |

As can be seen from Table 1, in Examples 1 to 3 including the pressure-sensitive adhesive strength stabilizer according to the present invention, the pressure-sensitive adhesive strength of the pressure-sensitive adhesive is quickly stabilized in room temperature and warming conditions and other physical properties such as endurance reliability, a heat resistance condition, and uniformity of light transmission are also maintained excellent. On the other hand, in Comparative Example 1 which does not include the pressure-sensitive adhesive strength stabilizer, it shows still high pressure-sensitive adhesive strength even after 4 days in a room temperature or warming condition, and thus it is expected that a long time may be consumed for stabilization, for example, aging, of the pressure-sensitive adhesive strength

1. A pressure-sensitive adhesive composition, including interpenetrating polymer network in a cured state,
wherein the composition comprises an acrylic resin, a multifunctional crosslinking agent and a pressure-sensitive adhesive strength stabilizer.

2. The pressure-sensitive adhesive composition of claim 1, wherein the acrylic resin has a weight average molecular weight of 1,000,000 or more.

3. The pressure-sensitive adhesive composition of claim 1, wherein the acrylic resin is a polymer of a monomer mixture comprising 80 to 99.9 parts by weight of a (meth)acrylic acid ester monomer and 0.1 to 20 parts by weight of a crosslinking monomer.

4. The pressure-sensitive adhesive composition of claim 1, wherein the multifunctional crosslinking agent is one or more selected from the group consisting of an isocyanate compound, an epoxy compound, an aziridine compound, and a metal chelate compound.

5. The pressure-sensitive adhesive composition of claim 1, wherein the multifunctional crosslinking agent is an isocyanate compound.

6. The pressure-sensitive adhesive composition of claim 1, wherein the multifunctional crosslinking agent is comprised in an amount of 0.01 to 10 parts by weight relative to 100 parts by weight of the acrylic resin.

7. The pressure-sensitive adhesive composition of claim 1, wherein the pressure-sensitive adhesive strength stabilizer comprises a hydroxy group, an amine group, a carboxyl group or an epoxy group.

8. The pressure-sensitive adhesive composition of claim 1, wherein the pressure-sensitive adhesive strength stabilizer is polyol or polyamine.

9. The pressure-sensitive adhesive composition of claim 8, wherein polyol or polyamine is divalent to hexavalent polyol or polyamine, and has a molecular weight of 50 to 3,000.

10. The pressure-sensitive adhesive composition of claim 1, wherein the pressure-sensitive adhesive strength stabilizer is one or more selected from the group consisting of alkyleneglycol, dialkyleneglycol, benzenediol, benzenetriol, dialcoholamine, trialcoholamine, arabitol, mannitol, isomalt, glycerol, xylitol, sorbitol, maltitol, erythritol, ribitol, dulcitol, lactitol, threitol, iditol, polyglycitol, alkylenediamine, alkenylenediamine, phenylenediamine and n-aminoalkyl alkanediamine.

11. The pressure-sensitive adhesive composition of claim 1, wherein the pressure-sensitive adhesive strength stabilizer is comprised in an amound of 0.1 to 10 equivalents relative to 1 equivalent of the multifunctional crosslinking agent.

12. The pressure-sensitive adhesive composition of claim 1, further comprising a multifunctional acrylate and a polymerization initiator.

13. The pressure-sensitive adhesive composition of claim 12, wherein the multifunctional acrylate is a bifunctional, a trifunctional, a tetrafunctional, a pentafunctional, or a hexafunctional acrylate.

14. The pressure-sensitive adhesive composition of claim 12, wherein the multifunctional acrylate is comprised in an amount of 5 to 40 parts by weight relative to 100 parts by weight of the acrylic resin.

15. The pressure-sensitive adhesive composition of claim 12, wherein the polymerization initiator is one or more selected from the group consisting of a thermal initiator and a photo-initiator.

16. The pressure-sensitive adhesive composition of claim 12, wherein the polymerization initiator is comprised in an amount of 0.2 to 20 parts by weight relative to 100 parts by weight of the acrylic resin.

17. The pressure-sensitive adhesive composition of claim 1, further comprising 0.01 to 5 parts by weight of a silane coupling agent, relative to 100 parts by weight of the acrylic resin.

18. A polarizer comprising:
a polarizing film or polarizing element; and
a pressure-sensitive adhesive layer formed on one or both sides of the polarizing film or polarizing element, the pressure-sensitive adhesive layer comprising a cured product of the pressure-sensitive adhesive composition according to claim 1.

19. The polarizer of claim 18, wherein the pressure-sensitive adhesive layer has a gel content of 80% to 99%,
the gel content being expressed by the General Formula 1:
Gel Content (%)=B/A×100, [General Formula 1]
where A represents a weight of the pressure-sensitive adhesive, and B represents a dry weight of an undissolved part of the pressure-sensitive adhesive after soaking the pressure-sensitive adhesive in ethyl acetate at room temperature for 48 hours.

20. A liquid crystal display comprising a liquid crystal panel in which the polarizer according to claim 18 is attached on one or both sides of a liquid crystal cell.
